(19) United States
(12) Patent Application Publication
(10) Pub. No.: US 2009/0071014 A1
(43) Pub. Date: Mar. 19, 2009

(54) Flexible strip trimmer

(76) Inventor: Cornelius Chow, Chula Vista, CA (US)

Correspondence Address: HARRY V. MCGAHEY JR., 1532 SIXTH AVENUE, SAN DIEGO, CA, 92101, US

(21) Appl. No.: 12/214,586

(22) Filed: Jun. 20, 2008

Related U.S. Application Data
(62) Division of application No. 11/900,966, filed on Sep. 13, 2007.

(51) Int. Cl. B26B 27/00

(52) U.S. Cl. 30/275.4

(57) ABSTRACT

A flexible strip trimmer device with a housing capable of holding an axle on one end, a circular cutting blade having a rotatably operable circumferentially extending cutting edge, the blade being mounted for rotary motion on the axle, a fastening to anchor the cutting blade to the axle at the outwardly directed outer end of the axle, the housing having a stop to guide the motion of the blade along the desired axis of motion for cutting, a recess in the stop in the cutting blade's radial plane which is sized to receive a portion of the cutting edge of the blade, the cutting blade traversing the recess so that a portion of it extends into the stop, and a handle attached to the housing.

### CROSS REFERENCE TO RELATED APPLICATIONS

This is a division of application Ser. No. 11/900,966, filed on Sep. 13, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of flexible strip trimmers and more specifically to flexible strip trimmers that can be used any place flexible material needs to be trimmed off. Typical examples include bookbinding, document binding, furniture construction and furniture repair. However this device will work on any flexible material that can be cut by the circular blade.

Many processes such as bookbinding and furniture lamination require that strips of excess flexible materials be removed from the items involved. There are other flexible strip trimmers which have been designed, but portability and efficiency has heretofore been limited.

U.S. Pat. No. design 234,490 (Mar. 18, 1975 Barlow, Peter) discloses a laminate trimmer with a triangular blade.

U.S. Pat. No. 3,268,579 (Dec. 21, 1971 Roche, Edward) discloses a plastic laminate trimmer utilizing a motorized routing tool.

U.S. Pat. No. D425,548 (May 23, 2000 Rellinger, Michael) discloses a trimmer design.

U.S. Pat. No. 2,378,249 (Jul. 7, 1944 Ruth, Roger) discloses a flat trimmer board.

U.S. Pat. No. 2,263,431 (Jun. 8, 1939 White, Leslie) discloses a motorized grass trimmer with a circular blade.

Many of the current trimmers require power, are dangerous to use, or tend to give jagged and irregular trimming. There is a great need for a portable flexible strip trimmer which is accurate, safe and easily used. This device meets that need.

### BRIEF SUMMARY OF THE INVENTION

The primary object of the invention is to provide a better method of trimming flexible strips wherever they may be used

Another object of the invention is to provide a better method of trimming flexible thermal strips used in book binding.

Another object of the invention is To provide a better method of trimming flexible laminating strips off of furniture during construction and repair.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a flexible strip trimmer device comprising: a housing capable of holding an axle on one end, an axle with an inwardly directed inner end anchored to the housing, a circular cutting blade having a rotatably operable circumferentially extending cutting edge, said blade being mounted for rotary motion on said axle, a fastening means to anchor the cutting blade to the axle at the outwardly directed outer end of the axle, the housing having a stop to guide the motion of the blade along the desired axis of motion for cutting, a recess in the stop in the cutting blade's radial plane which is sized to receive a portion of the cutting edge of the blade, the cutting blade traversing the recess so that a portion of it extends into the stop, a cover to enclose the circular cutting blade in the housing which leaves part of the cutting blade exposed at its border, and a handle attached to the housing.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 8B is a perspective view of the invention in use trimming excess bookbinding material off of a document being bound.

FIG. 10 is a perspective view of the assembled invention from below.

FIG. 13 is an exploded view of the invention from below.

FIG. 14 is an exploded view of another embodiment of the invention from below.

FIG. 14 is an exploded view of another embodiment of the invention from below.

FIG. 15 is another exploded view showing the preferred embodiment where the axle and the axle receptacle is visible.

FIG. 16 is a perspective view of the invention when used to trim furniture.

FIG. 17 is a perspective view of an embodiment of the invention without a blade cover.

FIG. 18 is an exploded view of an embodiment of the invention without a blade cover.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

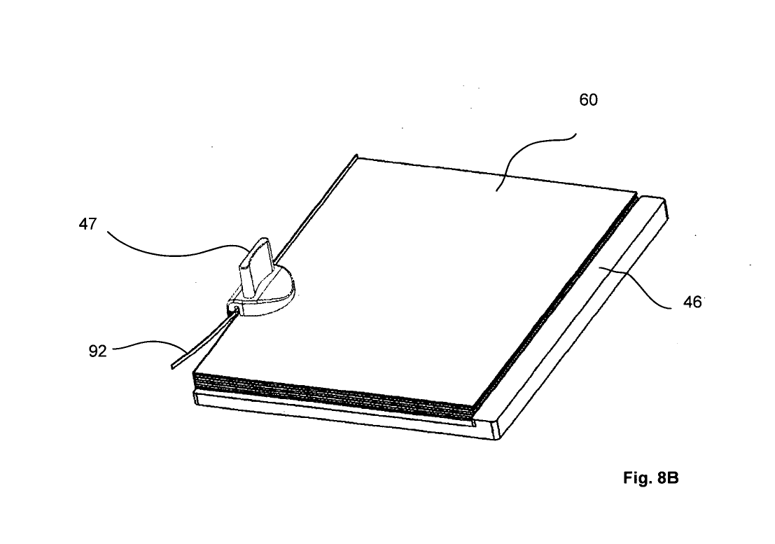

Turning first to FIG. 8B there is shown a perspective view of the flexible strip trimmer device (47) in use to trim off the excess of a flexible thermal strip composed of the hot melt material used during a bookbinding process. The flexible Strip Trimmer can be seen near the lower part of the view removing a portion of excess thermal strip hot melt material (92) from the document (60). As the trimmer (47) is moved along the trim guided by the stop, it cleanly slices off the excess free piece (97) of hot melt material which can then be disposed of. A document holder (46) is typically used to keep the document (60) steady during the trimming process.

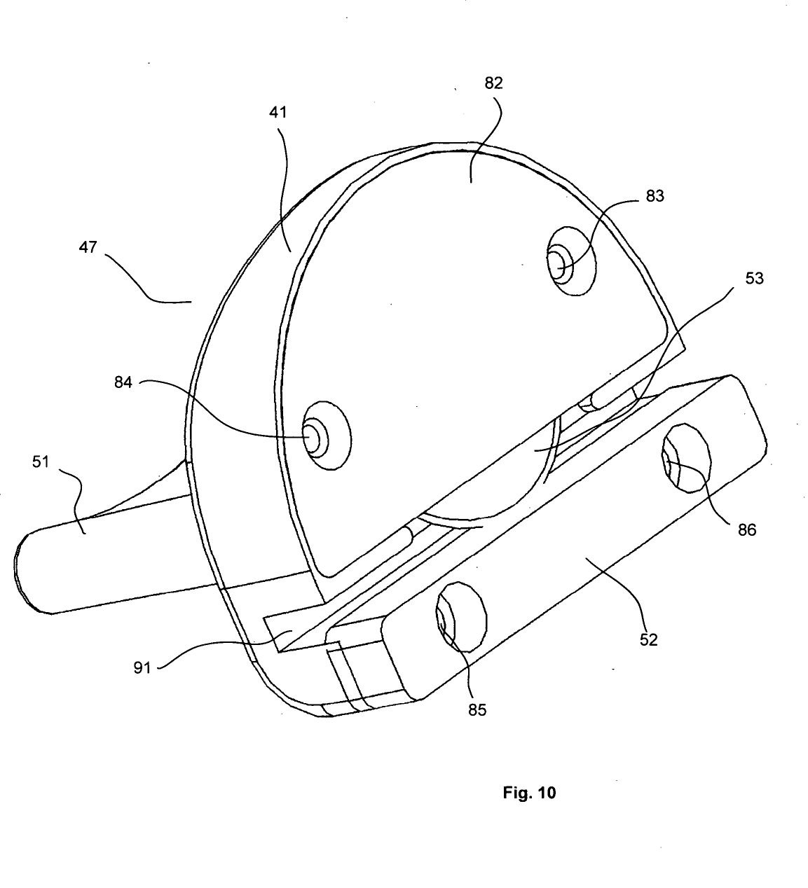

FIG. 10 shows a close up perspective view of an assembled trimmer (47). Visible is the housing (41) capable of holding the axle or spindle on one end, the circular cutting blade (53) which is mounted for rotary motion, having a rotatably operable circumferentially extending edge, and the stop (52) to guide the blade along the desired edge to be trimmed clean. The trimmer is manipulated by the operator using the handle (51). In the preferred embodiment the handle is in line with the axis of the axle holding the circular cutting blade (53). The handle can also be parallel but not in line with the axle. Also, the handle and the housing may be manufactured as one piece, or they may be separate parts. The recess (91) in the stop sized to receive part of the blade is also visible. The blade cover (82) leaves part of the blade (53) exposed at the cover's border as the blade traverses the recess (91) and extends into the stop (52). The left attachment anchor means (84) for the blade cover (82) and the right attachment anchor means (83) for the blade cover (82) can be seen in the location on the preferred embodiment. The stop left anchor attachment means (85) and the stop right anchor attachment means (86) of the stop (52) for the preferred embodiment are visible towards the bottom of the diagram.

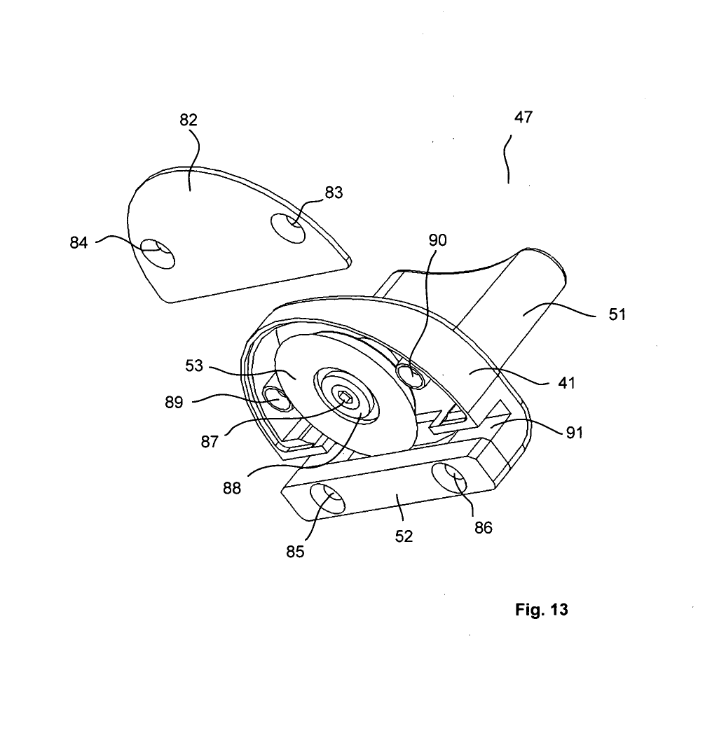

FIG. 13 is an exploded view of the trimmer (47) from below showing the inside of the housing (41). The blade cover (82) has been removed to show the circular cutting blade (53) attached to the housing (41). This cover (82) is used to enclose the circular cutting blade (53) in the housing (41). An anchor means is used to attach the blade cover (82) enclosing the circular cutting blade (53) inside the housing. In the preferred embodiment, the circular cutting blade (53) is attached to the axle by a bushing (88) between the blade fastening means (87) and the axle which holds the circular trimmer blade (53) onto the axle to reduce or prevent axial movement of the blade. In the preferred embodiment the bushing is of a fixed size but it may also be adjustable in length. A blade fastening means (87) is used to anchor the bushing to the axle. In the preferred embodiment the axle is of a fixed size but it may also be adjustable in length. In the preferred embodiment the blade fastening means is a countersunk hex shaped bolt. The bushing (88) in the preferred embodiment is also used to hold the blade (53) in place. The axle itself cannot be seen in FIG. 13 because it is hidden by the blade (53), the bushing (88) and the blade fastening means (87), but it is anchored to the bottom surface at its inwardly directed inner end to the inside of the housing. In the preferred embodiment, the blade cover left attachment means receptacle (89) and the blade cover right attachment means receptacle (90) are visible. Also, the stop left anchor attachment means (85) and the stop right anchor attachment means (86) of the stop (52) can be seen. These use an anchor means to attach the trimmer blade stop (52) to the trimmer housing (41) in the preferred embodiment. The recess (91) in the stop which is in the cutting blade's radial plane is also visible. The circular cutting blade (53) can be seen traversing the recess (91) so that a portion of it extends into the stop (52).

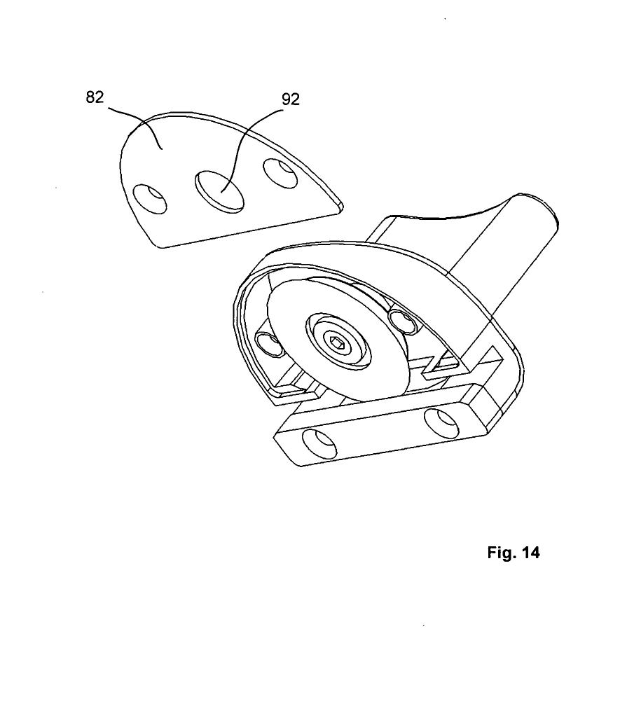

FIG. 14 is an exploded view of another embodiment of the invention from below. The blade cover (82) is shown with an access orifice (92) that gives access to the blade for increased access, replacement, and adjustment of the anchor means for the circular cutting blade. In the preferred embodiment, the blade cover is semi-circular, but the blade cover, if present, can be any shape so long as it covers part of the blade's cutting edge.

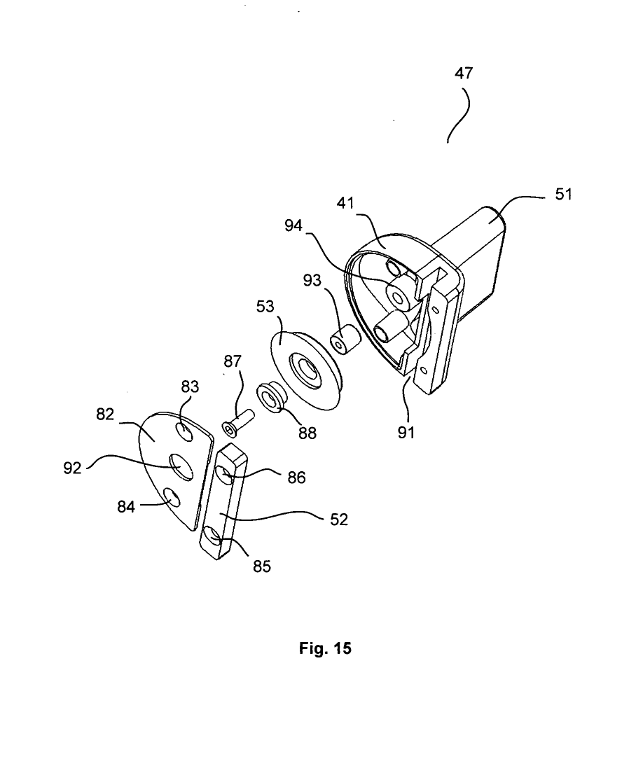

FIG. 15 is an exploded view of a preferred embodiment showing the blade (53), which is mounted for rotary motion on the axle (93), which is removably attached because the inwardly directed inner end of the axle can be inserted into an axle anchoring receptacle (94) attached to the inner wall of the housing. Also the attachment means (87) for the outwardly directed outer end of the axle (93) for the blade (53) is shown prior to being inserted into the bushing (88) in the preferred embodiment.

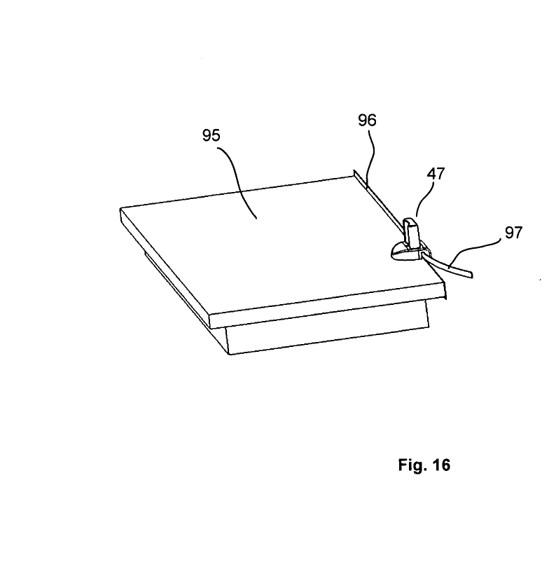

FIG. 16 is a perspective view of the invention when used to trim furniture. A piece of furniture (95) is shown with an excess piece of laminate or other flexible trim (96) which needs to be removed. As the trimmer (47) is moved along the trim guided by the stop, it cleanly slices off the excess free piece (97) of laminate which can then be disposed of.

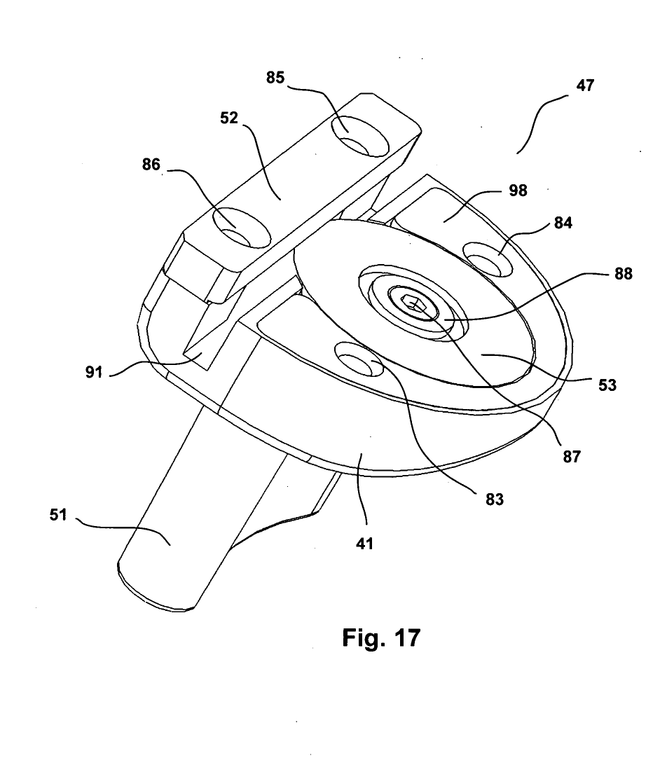

FIG. 17 is a perspective view of an embodiment of the invention without a blade cover. Instead of having a blade cover, the blade (53) is surrounded by a blade border (98) that does not cover the blade.

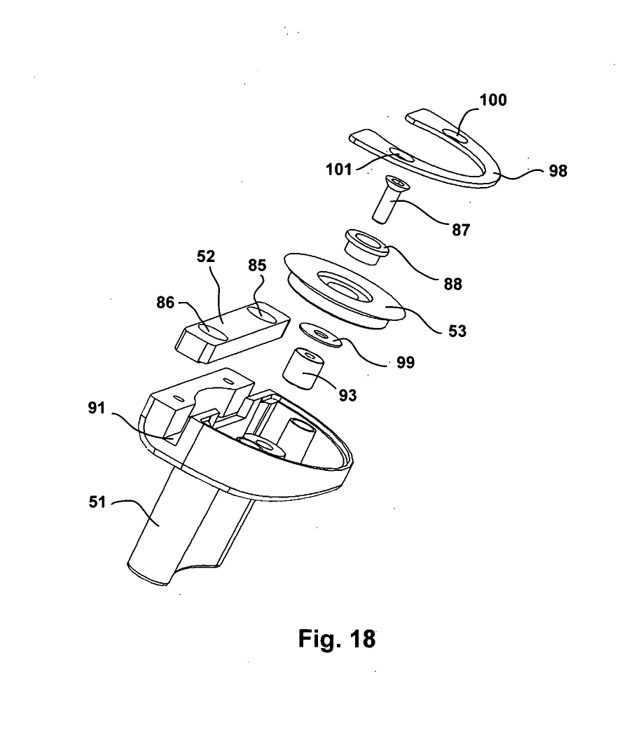

FIG. 18 is an exploded view of an embodiment of the invention without a blade cover and having a washer (99) between the blade (53) and the axle (93). Any embodiment of the trimmer may or may not have this washer (99) between the blade (53) and the axle (93). Instead of having a blade cover, the blade (53) in this embodiment is surrounded by a blade border (98) that does not cover the blade. The blade border is anchored to the trimmer by a two screw guide openings (100) and (101).

In the preferred embodiment, the blade is at a 90 degree angle to the axis of the axle it attached to. However, the blade could be set at any angle to the axle it is attached to. Furthermore, the size of the trimmer can be adjusted so that it is sufficiently large to trim laminates off of furniture during construction or repair. Or it can be made small so the blade is of a small enough size to trim excess thermal material off of documents being bound during document binding and book binding processes.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A flexible strip trimmer device comprising:
a housing capable of holding an axle on one end;
an axle with an inwardly directed inner end anchored to the inside of the housing;
a circular cutting blade having a rotatably operable circumferentially extending cutting edge, said blade being mounted for rotary motion on said axle;
a fastening means to anchor the cutting blade to the axle at the outwardly directed outer end of the axle;
the housing having a stop to guide the motion of the blade along the desired axis of motion for cutting;
a recess in the stop in the cutting blade's radial plane which is sized to receive a portion of the cutting edge of the blade;
the cutting blade traversing the recess so that a portion of it extends into the stop;
a blade cover to enclose the circular cutting blade in the housing which leaves part of the cutting blade exposed at its border; and
a handle attached to the housing.

2. The Flexible Strip Trimmer device as claimed in claim 1 wherein the blade is at a 90 degree angle to the axis of the axle it is attached to.

3. The flexible strip trimmer device as claimed in claim 1 wherein the blade position relative to the stop can be raised or lowered by adjusting the length of the axle.

4. The flexible strip trimmer device as claimed in claim 1 wherein there is a bushing between the circular cutting blade and the fastening means to prevent axial movement of the cutting blade on the axle.

5. The flexible strip trimmer device as claimed in claim 4 wherein the blade position relative to the stop can be raised or lowered by adjusting the length of the bushing.

6. The flexible strip trimmer device as claimed in claim 1 wherein the housing is anchored to the stop by an anchor means.

7. The flexible strip trimmer device as claimed in claim 1 wherein the housing contains a means for removably attaching the axle.

8. The flexible strip trimmer device as claimed in claim 1 wherein the cover enclosing the circular blade in the housing is attached to the housing by an anchor means.

9. The flexible strip trimmer device as claimed in claim 1 wherein the handle is in line with the axle of the circular cutting blade.

10. The flexible strip trimmer device as claimed in claim 1 wherein the handle is parallel with the axle of the circular cutting blade.

11. The flexible strip trimmer device as claimed in claim 1 wherein the housing for the blade is semi-circular shaped.

12. The flexible strip trimmer device as claimed in claim 1 wherein the handle and the housing are manufactured as one piece.

13. The flexible strip trimmer device as claimed in claim 1 wherein the blade cover contains an access orifice for increased access, replacement, and adjustment of the anchor means for the circular cutting blade.

14. The flexible strip trimmer device as claimed in claim 1 wherein the inwardly directed end of the axle is held in place by an axle anchoring receptacle.

15. The flexible strip trimmer device as claimed in claim 1 wherein the blade is sized to trim excess thermal material off of documents being bound during document binding processes.

16. The flexible strip trimmer device as claimed in claim 1 wherein the blade is sized to trim laminates off of furniture during construction or repair.

17. The flexible strip trimmer device as claimed in claim 1 wherein the cutting edge of the blade is protected by a blade border instead of a blade cover, and the blade border does not cover the surface of the blade at any point.

18. The flexible strip trimmer device as claimed in claim 1 wherein:
the blade is at a 90 degree angle to the axis of the axle it is attached to;
there is a bushing between the circular cutting blade and the fastening means to prevent axial movement of the cutting blade on the axle;
the housing is anchored to the stop by an anchor means;
the housing for the blade is semi-circular shaped;
the housing contains a means for removably attaching the axle;
the handle and the housing are manufactured as one piece;
a blade cover enclosing the circular blade in the housing is attached to the housing by an anchor means;
the handle is in line with the axle of the circular cutting blade.

19. The flexible strip trimmer device as claimed in claim 18 wherein the blade cover contains an access orifice for increased access, replacement, and adjustment of the anchor means for the circular cutting blade.

20. The flexible strip trimmer device as claimed in claim 1 wherein:
the blade is at a 90 degree angle to the axis of the axle it is attached to;
there is a bushing between the circular cutting blade and the fastening means to prevent axial movement of the cutting blade on the axle;
the housing is anchored to the stop by an anchor means;
the housing for the blade is semi-circular shaped;
the handle and the housing are-manufactured as one piece;
the cutting edge of the blade is protected by a blade border, but the blade border does not cover the surface of the blade at any point.
